(19) United States
(12) Patent Application Publication
(10) Pub. No.: US 2024/0300703 A1
(43) Pub. Date: Sep. 12, 2024

(54) RUBBER STOPPER

(71) Applicant: DAIKYO SEIKO, LTD., Sano-shi (JP)

(72) Inventor: Hiroshi SUTO, Sano-shi (JP)

(73) Assignee: DAIKYO SEIKO, LTD., Sano-shi (JP)

(21) Appl. No.: 18/254,727

(22) PCT Filed: Jun. 29, 2021
(86) PCT No.: PCT/JP2021/024472

§ 371 Date: May 26, 2023

(30) Foreign Application Priority Data
Dec. 23, 2020 (JP) 2020-214197

(51) Int. Cl. B65D 39/00; A61J 1/14; B65D 51/00

(52) U.S. Cl. CPC B65D 39/0023; A61J 1/1406; B65D 51/002; A61J 2200/10

(57) ABSTRACT

To provide a rubber stopper capable of suppressing occurrence of coring. Provided is a rubber stopper including a canopy portion having an upper surface and a lower surface, and a leg portion provided on the lower surface of the canopy portion, in which the leg portion has a tapered base portion at the center on a lower surface side of the canopy portion, and a curvature radius R1 of the tapered base portion is 2 mm or more and 4 mm or less.

### TECHNICAL FIELD

The present invention relates to a rubber stopper. More specifically, the present invention relates to a rubber stopper capable of preventing occurrence of coring.

### BACKGROUND ART

There exist a vial and an ampoule as containers for storing a drug solution. The vial is sealed by a rubber stopper capped to a lip of a pharmaceutical container mainly made of glass, plastic, and the like. Sticking a needle into the rubber stopper enables communication with an instrument such as a syringe without opening (or breaking) the container; therefore, work can be hygienically performed so as not to open the container carelessly.

On the other hand, a high degree of quality characteristics and physical characteristics are required for the rubber stopper that is applied to the lip of the pharmaceutical container. For example, the quality characteristics required for the rubber stopper used for sealing or capping a lip of a vial for storing a drug product such as antibiotics should conform to the test for rubber closure for aqueous infusions of Japanese Pharmacopoeia due to its purpose of use. Moreover, it is necessary to contrive to suppress occurrence of a phenomenon that part of rubber (rubber piece) forming the rubber stopper is scraped (coring) when sticking a needle into the rubber stopper from a needle insertion portion.

Here, for example, Patent Literature 1 discloses a rubber stopper for a vial including a lid portion having an upper surface and a lower surface, and a leg portion provided on the lower surface of the lid portion, in which a needle piercing portion at the center of the lid portion is recessed so that the lower surface of the lid portion is positioned between an upper surface and an lower surface of the needle piercing portion, and a lower surface of the canopy portion has a flat (planar) shape to thereby suppress coring.

Moreover, Patent Literature 2 discloses a rubber stopper for a vial including a canopy portion having a flange, a puncturing area formed to have a recessed portion on a top surface of the canopy portion and formed to longitudinally traverse the canopy portion from the recessed portion to a bottom surface, and a leg portion formed on the bottom surface of the canopy portion so as to protrude downward at an outer position of the puncturing area with respect to an axial center of the canopy portion, in which the puncturing area is formed of rubber with a rubber hardness from 20 to 35, and the top surface other than the recessed portion of the canopy portion is formed of rubber with a rubber hardness of 58 to 90 to thereby suppress coring because a plurality of materials are used.

Furthermore, Patent Literature 3 discloses a vial and a sealing device used for the same, in which a sealing member corresponding to a rubber stopper can be easily switched from a half-capped posture where the interior of a vial housing communicates with outside space to a sealed posture where the communication is cut off, and the sealed posture can be positively maintained after sealing with a simple structure inexpensively.

### CITATION LIST

### Patent Literature

PTL 1: JP2004-24384A
PTL 2: WO2012/090328 pamphlet
PTL 3: JP2011-50699A

### SUMMARY OF INVENTION

### Technical Problem

However, measures against coring performed in related art is not sufficient yet. In view of the above, a prime objective of the present invention is to solve the problem of occurrence of coring.

### Solution to Problem

That is, the present invention provides a rubber stopper including a canopy portion having an upper surface and a lower surface, and a leg portion provided on the lower surface of the canopy portion, in which the leg portion has a tapered base portion at the center on a lower surface side of the canopy portion, and a curvature radius R1 of the tapered base portion is 2 mm or more and 4 mm or less.

In the present invention, a length P of an inner wall of the leg portion may be longer than a length D of the leg portion itself, which is greater than 100% and less than 160% with respect to the length D of the leg portion itself.

In the present invention, a distance R2 between a start point and an end point of an arc including an apex of the tapered base portion may be 8 mm or less.

In the present invention, the canopy portion may have a recessed portion at the center on an upper surface side of the canopy portion, and an outer diameter R3 of the recessed portion may be 90% or less with respect to the distance R2.

In the present invention, the canopy portion may have a needle sticking portion into which a needle is stuck, and a thickness E of the needle sticking portion may be 60% or more and less than 100% of a thickness C of the canopy portion.

In the present invention, the thickness E of the needle sticking portion may be 3 mm or less.

In the present invention, the thickness E of the needle sticking portion may be 15% or more and 40% or less with respect to the length D of the leg portion itself.

In the present invention, the leg portion may have a cutout at least at one place.

In the present invention, the leg portion may be provided with a ring-shaped convex portion on an outer peripheral surface on an end side of the leg portion.

The rubber stopper according to the present invention may be used for sealing a lyophilized drug product.

### Advantageous Effects of Invention

According to the present invention, a rubber stopper capable of suppressing occurrence of coring can be provided.

Note that the effects described here are not always limited to the above, and may be some of effects described in the specification.

### BRIEF DESCRIPTION OF DRAWINGS

A of FIG. 1 is a vertical-lateral cross-sectional view illustrating an example of an embodiment of a rubber stopper according to the present invention, which is a cross-sectional view taken along P-P line of FIG. 4. B of FIG. 1 is a partially enlarged view of A of FIG. 1.

FIG. 2 is a view illustrating an example of the embodiment of the rubber stopper according to the present invention from a horizontal-lateral direction.

FIG. 3 is a view illustrating an example of the embodiment of the rubber stopper according to the present invention from a vertical upper direction.

FIG. 4 is a view illustrating an example of the embodiment of the rubber stopper according to the present invention from a vertical lower direction.

### DESCRIPTION OF EMBODIMENTS

Hereinafter, preferred embodiments of the present invention will be explained.

Embodiments described below are examples of a representative embodiment of the present invention, and the scope of the present invention should not be narrowly interpreted based on these examples.

As illustrated in FIG. 1, a rubber stopper 1 according to the present invention includes a canopy portion 11 having an upper surface and a lower surface, and a leg portion 12 provided on the lower surface of the canopy portion 11, in which the leg portion 12 has a tapered base portion 10 with an approximately semispherical shape at the center on a lower surface side of the canopy portion, and a curvature radius R1 of the tapered base portion 10 is 2 mm or more and 4 mm or less.

In the above Patent Literature 1, a thickness of the canopy portion and a length of the leg portion are approximately the same, and the length of the leg portion is short; therefore, a shape of the leg portion which can secure stability of the rubber stopper in a half-capped state as in a rubber stopper for a lyophilized drug product is not mentioned though the problem of coring is solved, and there is also a problem that there is a tendency to fall over at the time of being conveyed.

Moreover, in the above Patent Literature 2, the rubber stopper is manufactured using a plurality of rubber materials with different hardnesses; therefore, there is a problem that manufacturing costs are high.

Furthermore, in the above Patent Literature 3, a holding member and a protective lid are necessary in the half-capped posture and the number of components is increased; therefore, there is a problem that manufacturing costs are increased.

In view of the above, the prevent invention, a prime objective of which is to solve the problem of occurrence of coring, provides a rubber stopper having the shape of the leg portion which can secure stability of the rubber stopper in the half-capped state as in the rubber stopper for the lyophilized drug product, suppressing occurrence of coring even when using a single rubber material with the same hardness, reducing the number of components, and suitable for lyophilization with low manufacturing costs.

The curvature radius R1 is a radius corresponding to an arc including an apex of the tapered base portion 10 as illustrated in FIG. 1. A center point of the curvature radius R1 is on a perpendicular line (central axis) extending from the apex of the tapered base portion 10 toward the center of the leg portion 12, and a start point and an end point of the arc are set as an “R stop portion 1”. The “R stop portion 1” is part of a length P of an inner wall of the leg portion 12. When the curvature radius R1 is less than 2 mm, the inside of the leg portion 12 becomes too small, and a possibility that a hollow needle scrapes the inner wall of the leg portion 12 to cause coring is increased. Moreover, when the curvature radius R1 exceeds 4 mm, a molding defect is likely to occur in the leg portion 12.

The curvature radius R1 is, more preferably, 2 mm or more and 3 mm or less.

In the rubber stopper 1 according to the present invention, occurrence of coring is suppressed in both cases where a plastic needle is used and where a metallic needle is used as a needle as illustrated in later-described examples. In particular, the plastic needle is used for a closed system drug transfer device (CSTD); therefore, the rubber stopper 1 according to the present invention can be used also for sealing a drug product for the CSTD.

As a material for forming the rubber stopper 1 according to the present invention, for example, synthetic rubbers such as a butyl rubber, an isoprene rubber, a butadiene rubber, a halogenated butyl rubber, ethylene-propylene rubber, and a silicone rubber or natural rubber and so on can be cited. The present invention can be also applied to a so-called laminated rubber stopper in which, for example, a film containing fluorine-based resin is laminated on a rubber stopper. As the above fluorine-based resin, for example, a tetrafluoroethylene resin, a chlorotrifluoroethylene resin, a tetrafluoroethylene-hexafluoropropylene copolymer resin, a vinylidene fluoride resin, a vinyl fluoride resin, a tetrafluoroethylene-ethylene copolymer resin, a chlorotrifluoroethylene-ethylene copolymer resin, and the like can be cited. A thickness of the film to be laminated can be, for example, 0.002 mm or more and 0.5 mm or less. Moreover, a hardness of the rubber stopper 1 according to the present invention is, for example, 25 to 45, and preferably 28 to 40.

In the present invention, it is preferable that a length P of the inner wall of the leg portion 12 (a length from the apex of the tapered base portion 10 to a flattening point (see A of FIG. 1) on a ground side of the leg portion 12 (at an inner end of the leg portion 12 in R stop portions 2) is longer than a length D of the leg portion 12 itself (a shortest distance from the lower surface of the canopy portion to a plane to be flat on the ground side of the leg portion 12 (see A of FIG. 1)), and is preferably greater than 100% and less than 160% with respect to the length D of the leg portion 12 itself, and is more preferably greater than 100% and less than 145%. According to the above, it is possible to prevent that the film is extended too much when laminating the leg portion 12 and to prevent that a molding defect such as damage of the film is caused.

In the present invention, a distance R2 between the start point and the end point of the arc including the apex of the tapered base portion 10 is preferably 8 mm or less, and more preferably 6 mm or less. When the distance R2 exceeds 10 mm, moldability is not good, and the film does not easily stick to the leg portion. When the distance R2 is less than 4 mm, a center needle is likely to scrape the inner wall surface, and coring is likely to occur. Note that the distance R2 is a chord length of the arc including the apex of the tapered base portion 10 obtained by extending a horizontal line from the point of the “R stop portion 1” in a radial direction as illustrated in FIG. 1. The positions of the start point and the end point of the “R stop portion 1” can be defined by a position of an outer diameter R3 of a later-described recessed portion 111 or the length D of the leg portion 12 itself to be required. Furthermore, the positions of the start point and the end point of the “R stop portion 1” can be defined as the same height as an outer diameter position of an annular protrusion B provided on a lower surface of the canopy portion as illustrated in FIG. 1, or within a range of +10% of the height of the outer diameter position of the annular protrusion B.

Moreover, the “R stop portion 1” preferably exists on a tangent line extending to the central axis (line) in the “R stop portion 2 (on the R stop portion 1 side)” at the inner end of the leg portion. Since there is an inclination in the tangent line connecting the “R stop portion 1” and the “R stop portion 2 (R stop portion 1 side) at the end of the inner wall of the leg portion, the entire length of the leg portion 12 is shortened, and the volume of the leg portion 12 is increased, which can improve stability of the leg portion 12 and can improve stability of the entire rubber stopper 1. When not only the metallic needle but also a hollow needle such as the plastic needle having a larger diameter than the metallic needle is stuck diagonally, coring does not easily occur, and occurrence of coring can be avoided.

Note that as illustrated in FIG. 1, there are two points of the “R stop portion 2” on a curved line provided at the inner end of the leg portion, including a flattening point on the ground side of the leg portion 12 (at the inner end of the leg portion 12) and a point on the “R stop portion 1” side. In the present invention, a curvature radius on the curved line connecting two points of the “R stop portion 2” is preferably 0.1 to 1.0 mm, more preferably, approximately 0.5 mm.

Moreover, the relation between the curvature radius R1 and the distance R2 is 2R1>R2 or 2R1=R2. Furthermore, the curvature radius R1 and the distance R2 are between the center of the lower surface of the canopy portion and a height (position) of D/2 or higher from the end of the leg portion as illustrated in FIG. 1.

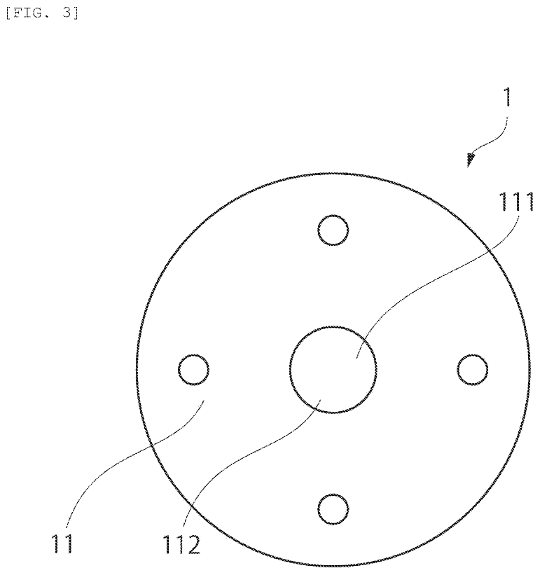

As illustrated in FIG. 1 and FIG. 3, the canopy portion 11 has the recessed portion 111 at the center on an upper surface side of the canopy portion, and the outer diameter R3 of the recessed portion 111 is preferably 90% or less with respect to the distance R2. According to the above, occurrence of coring can be further suppressed.

The canopy portion 11 provided with the recessed portion 111 at the center on the upper surface side of the canopy portion includes a needle sticking portion 112 to be a bottom surface of the recessed portion 111, into which a needle is stuck, and a thickness E of the needle sticking portion 112 is preferably 60% or more and less than 100% of a thickness C of the canopy portion. When setting to 60% or more, it is possible to prevent that the needle sticking portion 112 becomes too thin and is damaged to cause the leakage or the like of a drug solution. When setting to less than 100%, occurrence of coring can be further suppressed.

In this case, the thickness E of the needle sticking portion 112 is preferably 3 mm or less. When the thickness E of the needle sticking portion 112 exceeds 3 mm, the risk of occurrence of coring is increased. Needle sticking resistance generated when sticking the needle is also increased. A lower limit value of the thickness E of the needle sticking portion 112 is not particularly limited; however, the lower limit value is preferably 1 mm or more for maintaining self-hermeticity and barrier properties.

In this case, the thickness E of the needle sticking portion is preferably 15% or more and 40% or less with respect to the length D of the leg portion 12 itself. When setting to 15% or more, it is possible to prevent that the needle sticking portion 112 becomes too thin and damaged and prevent that the leakage or the like of a drug solution occurs. When setting to 40% or less, the risk of occurrence of coring can be suppressed.

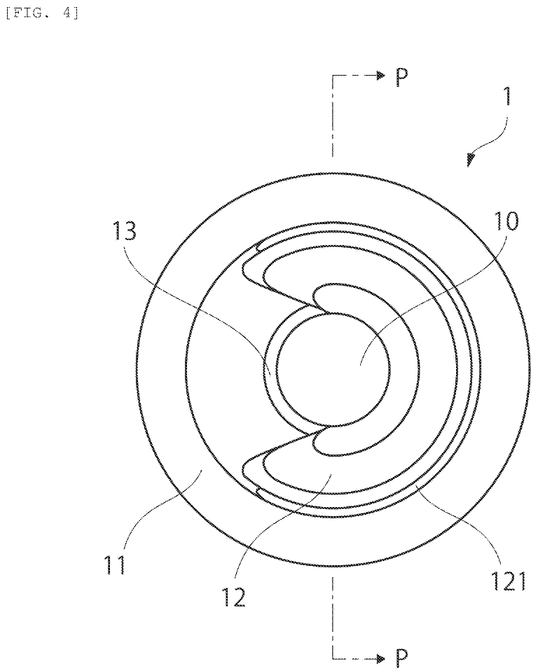

As illustrated in FIG. 4, it is preferable that the leg portion 12 contains, at the center thereof, a circular-shaped tapered base portion 10 having the same diameter as the needle sticking portion 112 and has a cutout 13 at one place so that more than half of a circumference that forms the tapered base portion 10 opens. When the cutout 13 is possessed at one place, a contact area to an inner wall of a lip is increased in the half-capped state as compared with a case of the leg portion 12 having a forked structure in which cutouts are formed at two places; therefore, occurrence of displacement or coming-off of the rubber stopper 1 can be suppressed. In order to prevent the rubber stopper 1 from coming off from the vial when the leg portion 12 stays standing so as to fit to the lip of a vial in the half-capped state, a convex portion 121 provided on an outer peripheral surface of the leg portion 12 is in a state of closely contacting the inner wall of the lip firmly, thereby fixing the rubber stopper 1. Accordingly, the rubber stopper 1 according to the present invention can be used for the lyophilized drug product and has stability even in the half-capped state. Moreover, the cutout 13 is possessed at one place; therefore, the rubber stopper 1 itself easily stands by itself, and it is possible to prevent the rubber stopper 1 from fall over at the time of being conveyed and to prevent docking in which the leg portions 12 closely contact each other.

A method of filling a pharmaceutical container with the lyophilized drug product is generally performed in the following order of (A) to (C).

(A) The drug product is put into a body of the pharmaceutical container under sterile conditions.
(B) Subsequently, lyophilization is performed in a lyophilizer in a state where the lip of the body of the pharmaceutical container is half-capped with the rubber stopper to thereby prevent mixing of foreign matter.
(C) After lyophilization, fully-capping is performed to seal the container, then, the container is taken out from the lyophilizer.

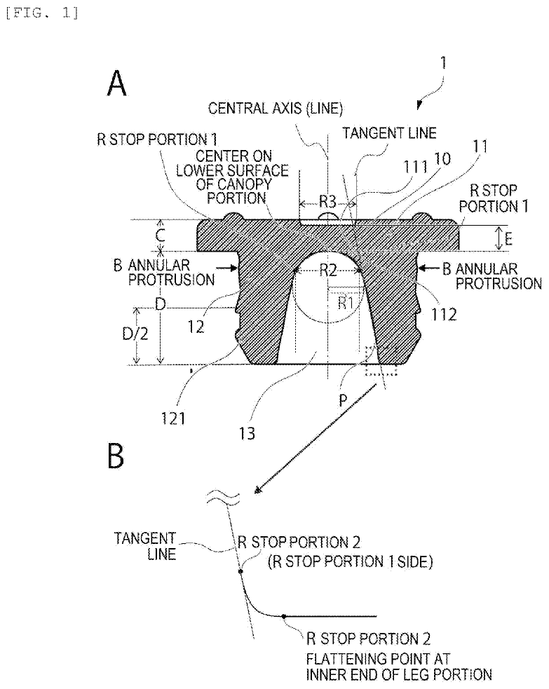

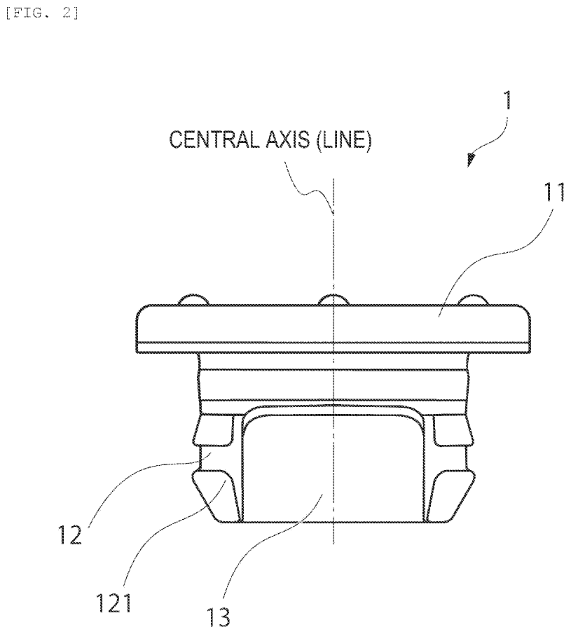

As illustrated in FIG. 2 and FIG. 4, the tapered and ring-shaped convex portion 121 is preferably formed on the outer peripheral surface of the leg portion 12 on the end side of the leg portion. According to the above, a tapered-shaped narrow portion functions as a guide for an inner wall surface of the lip of the body of the pharmaceutical container to realize smooth half-capping at the time of half-capping in the above process of (B), the contact area with respect to the inner wall surface of the lip is increased, and the rubber stopper 1 is fitted to the pharmaceutical container in a state of being fixed stably and firmly.

### EXAMPLES

Hereinafter, the present invention will be explained further in details based on the example illustrated in FIG. 1.

Note that the examples explained below are representative examples of the present invention, and the scope of the present invention should not be narrowly interpreted based on these examples.

### Test Example 1

A pharmaceutical container for a lyophilized drug product was capped with the rubber stoppers of Example 1 and Example 2, and the number of occurrence of coring was checked by using respective needles illustrated in Table 1 below.

### Example 1

The rubber stopper 1 made of chlorinated butyl rubber coated with a fluorine-based resin having the structure illustrated in FIG. 1 was prepared, which includes the canopy portion 11 having the upper surface and the lower surface, and the leg portion 12 provided on the lower surface of the canopy portion 11, in which the leg portion 12 has the tapered base portion 10 at the center on a lower surface side of the canopy portion, and the curvature radius R1 of the tapered base portion 10 is 2.65 mm. The length P of the inner wall of the leg portion 12 of the rubber stopper 1 is a length from the center of the lower surface of the canopy portion on the central axis to the “R stop portion 2” which is a flattening point at the end of the inner wall of the leg portion, which was 13.3 mm. The length D of the leg portion 12 itself was 10.2 mm. The distance R2 of the leg portion 12 on the lower surface side of the canopy portion was 4.6 mm. Furthermore, the canopy portion 11 is provided with the recessed portion 111 at the center on the upper surface side of the canopy portion, and the outer diameter R3 of the recessed portion 111 was 4.0 mm. Moreover, the canopy portion 11 has the needle sticking portion 112 into which the needle is stuck, and the thickness E of the needle sticking portion 112 was 2.5 mm.

### Example 2

The rubber stopper 1 made of chlorinated butyl rubber coated with a fluorine-based resin having the structure illustrated in FIG. 1 was prepared, which includes the canopy portion 11 having the upper surface and the lower surface, and the leg portion 12 provided at the lower surface of the canopy portion 11, in which the leg portion 12 has the tapered base portion 10 at the center on a lower surface side of the canopy portion, and the curvature radius R1 of the tapered base portion 10 is 3.30 mm. The length P of the inner wall of the leg portion 12 of the rubber stopper 1 is a length from the center of the lower surface of the canopy portion on the central axis to the “R stop portion 2” which is a flattening point at the end of the inner wall of the leg portion, which was 13.2 mm. The length D of the leg portion 12 itself was 10.3 mm. The distance R2 of the leg portion 12 on the lower surface side of the canopy portion was 5.3 mm. However, the canopy portion 11 is not provided with the recessed portion 111 at the center on the upper surface side of the canopy portion in the Example 2. Moreover, the canopy portion 11 has the needle sticking portion 112 into which the needle is stuck, and the thickness E of the needle sticking portion 112 was 3.3 mm.

Test results are shown in Table 1 below.

TABLE 1

Number of occurrence of coring
(unit: case)

| Name of needle | Needle | | Example 2 |
|---|---|---|---|
| manufacturer | material | Example 1 | (Different shape) |
| Company A | Plastic | 0/50 | 4/50 |
| Company B | Plastic | 0/50 | 4/50 |
| Company C | metal | 0/50 | 6/50 |

According to the result of the test example 1, it is suggested that occurrence of coring is suppressed by using the rubber stopper 1 according to the present invention including the canopy portion 11 having the upper surface and the lower surface, and the leg portion 12 provided on the lower surface of the canopy portion 11, in which the leg portion 12 has the tapered base portion 10 at the center on the lower surface side of the canopy portion, and the curvature radius R1 of the tapered base portion 10 is 2 mm or more and 4 mm or less. As illustrated in the above Table 1, in the rubber stopper 1 according to the present invention, coring was less likely to occur in both cases where the plastic needle is used and where the metal needle is used. Furthermore, it was found that when the thickness E of the needle sticking portion 112 is set to 3 mm or less, occurrence of coring is further suppressed.

### INDUSTRIAL APPLICABILITY

As apparent from the above, according to the present invention, it is possible to provide a rubber stopper that can solve the problem of occurrence of coring, having the shape of the leg portion capable of securing stability of the rubber stopper in the half-capped state as in the rubber stopper for the lyophilized drug product, suppressing occurrence of coring even when using a single rubber material with the same hardness, reducing the number of components, and suitable for lyophilization with low manufacturing costs.

### REFERENCE SIGNS LIST

1 rubber stopper
10 tapered base portion
11 canopy portion
111 recessed portion
112 needle sticking portion
12 leg portion
121 convex portion
13 cutout
R1 curvature radius of tapered base portion
R2 distance between start point and end point of arc including apex of tapered base portion
R3 outer diameter of recessed portion
B annular protrusion
C thickness of canopy portion
D length of leg portion itself
E thickness of needle sticking portion

1. A rubber stopper comprising:
a canopy portion having an upper surface and a lower surface; and
a leg portion provided on the lower surface of the canopy portion,
wherein the leg portion has a tapered base portion at the center on a lower surface side of the canopy portion, and
a curvature radius R1 of the tapered base portion is 2 mm or more and 4 mm or less.

2. The rubber stopper according to claim 1,
wherein a length P of an inner wall of the leg portion is longer than a length D of the leg portion itself, which is greater than 100% and less than 160% with respect to the length D of the leg portion itself.

3. The rubber stopper according to claim 2,
wherein a distance R2 between a start point and an end point of an arc including an apex of the tapered base portion is 8 mm or less.

4. The rubber stopper according to claim 3,
wherein the canopy portion has a recessed portion at the center on an upper surface side of the canopy portion, and
an outer diameter R3 of the recessed portion is 90% or less with respect to the distance R2.

5. The rubber stopper according to claim 1,
wherein the canopy portion has a needle sticking portion into which a needle is stuck, and
a thickness E of the needle sticking portion is 60% or more and less than 100% of a thickness C of the canopy portion.

6. The rubber stopper according to claim 5,
wherein the thickness E of the needle sticking portion is 3 mm or less.

7. The rubber stopper according to claim 5,
wherein the thickness E of the needle sticking portion is 15% or more and 40% or less with respect to the length D of the leg portion itself.

8. The rubber stopper according to claim 1,
wherein the leg portion has a cutout at least at one place.

9. The rubber stopper according to claim 8,
wherein the leg portion is provided with a ring-shaped convex portion on an outer peripheral surface on an end side of the leg portion.

10. The rubber stopper according to claim 1,
wherein the rubber stopper is used for sealing a lyophilized drug product.
